(19) United States
(12) Patent Application Publication
(10) Pub. No.: US 2007/0235001 A1
(43) Pub. Date: Oct. 11, 2007

(54) Rotary Engine with Two Rotors and Its Design Method

(76) Inventor: Liang Liang, Guangdong province (CN)

Correspondence Address: Raymond Y. Chan, 108 N. Ynez Avenue, Suite 128, Monterey Park, CA, 91754, US

(21) Appl. No.: 11/629,836

(22) PCT Filed: Jun. 15, 2005
(86) PCT No.: PCT/CN05/00853

§ 371 Date: Dec. 15, 2006

(30) Foreign Application Priority Data
Jun. 16, 2004 (CN) 200410049459.7

(51) Int. Cl. F02B 53/02

(52) U.S. Cl. 123/243; 123/241

(57) ABSTRACT

This invention provides a rotary engine and the type engine design method. This engine mainly has two nested rotors and a cylinder body. This invention publicizes in detail about the rotary engine movement principle and the work mechanism. This type engine can the automatic control compression ratio, the running rate be high, Structure simple and so on many kinds of merits.

### FIELD OF THE PRESENT INVENTION

This invention involves the engine domain, specifically involves a double rotors rotary engine, the design method, and the equipment.

### BACKGROUND OF THE PRESENT INVENTION

The present engine application mainly includes the piston engine or the triangular revolving rotary engine. These engine compression ratios are all fixed and cannot be controlled automatically.

The traditional piston engine also has the following shortcoming: the volume is big; need a big quality of flywheel; need the crank and so on the complex structural elements; the processing and the service are inconvenient also.

The triangular revolving rotary engine has following shortcoming: The compression ratio cannot adjust; biased revolving; oil consumption is large and so on inherent shortcoming.

In order to improve the traditional engine shortcoming, people propose many kinds of solution. There are many proposed design for double rotors rotary engine in the research field for many years.

The patent from American Patent office regarding rotary engine includes:

| Patent number (date | |
|---|---|
| of application) | Application name |
| 3985110 | TWO-ROTOR ENGINE |
| (Jan. 20, 1975) | |
| 6257196 | ROTARY DISC ENGINE |
| (Sep. 7, 1999) | |
| 5433179 | ROTARY ENGINE WITH VARIABLE |
| (Dec. 2, 1993) | COMPRESSION RATIO |
| 5622149 | HIGH-POWER ROTARY ENGINE WITH |
| (May 15, 1995) | VARIABLE COMPRESSION RATIO |
| 6293775 | SMALL ROBUST ROTARY INTRNAL |
| (Jul. 15, 2000) | COMBUSTION ENGINE HAVING HIGH |
| | UNIT POWER AND LOW |
| | MANUFACTURING COSTS |
| 6289867 | ROTARY ENGINE |
| (Mar. 10, 2000) | |

These patents all try hard on the double rotors rotary engine to obtain the breakthrough.

Includes in is a China's patented application: 03136630.9, 200410049459.7, 200410049459.7 is this application priority application.

### SUMMARY OF THE PRESENT INVENTION

A kind of double rotors rotary engine, comprising:

A, the air cylinder having an interior for the spatial shell, wherein the spatial shell has an outlet channel and an air inlet channel;

B, capable of opening and closing, a spindle mutually aims at a first and a second revolving rotor, each institute the rotor to contain two leaf blades, the leaf blades separate the cylinder block the housing into four cavity rooms;

C, a supply of fuel installment;

D, a support structure;

which further comprises:

E, a start structure, external force through start structure coupling to rotor on;

F, a guards against the bringing back, the external force impediment revolving rotor contra-rotation.

which also comprises:

G, a seal structure;

H, a cooling structure;

M, a lubricating gear;

In order to strengthen the engine's stability, the first revolving rotor quality is bigger than the second revolving rotor quality, prevented the reverse equipment function in the second revolving rotor. The above supply of fuel equipment may be the carburetor, the electrically controlled spray hole and so on, the fuel type may be all liquids or the gas type fuel.

The start structure including starts the electrical machinery, starts the electrical machinery function in to state the second revolving rotor, said the support structure including further to contain the output power unit, this dynamic output installment function in first revolving rotor.

The start structure further includes the locking gear, on the locking gear function and the rotor, after a rotor is locked, another rotor changes to when establishes the position, is locked the rotor to be possible to revolve, but another rotor is locked, so circulates;

The locking gear can also be as follow: the locking gear only locks a rotor, but another rotor has the unblanking function, when the rotor changes to certain angle, after is locked, another rotor changes to when establishes the position, opening the locking rotor, and the process repeats;

The above locking gear only affects the unloading phase, uses in for compressing the gas between two rotors, after the engine rotational speed arrives at a certain speed the locking gear no longer have the fixed function.

The start structure including the start auxiliary power coupling structure, said the start auxiliary power coupling structure including to connect separately to two rotors on the start turntable one and the start turntable two, as soon as starts the electrical machinery or the exogenic process after starts the turntable to actuate the first rotor to compress the second rotor, transfers affects to the turntable two actuates the second rotor to compress the first rotor, so circulates, until the engine starts the work.

Above prevented the reverse equipment is the gear coupling, and said the gear is the entire tooth or not the incomplete tooth.

Prevented the reverse equipment is the electromagnetism form, including the electromagnet, with the magnetic induction material, said the magnetic induction material and the rotor is connected, when the rotor compresses the gaseous mixture, the electromagnet works, holds the magnetic induction material, after the gaseous mixture detonation acting, the electromagnet does not work or impels the rotor to rotate forward.

On the air cylinder endophragm the establishment has the gas buffer cavity which is interlinked with the outside atmosphere or is not interlinked, this gas buffer cavity and the bean separately are located in two section of air cylinder circular arcs which the air inlet channel and the air outlet channel divide, In the air cylinder will also establish has at least a high temperature compressed gas feedback channel, said feeds back the channel the length to be bigger than the revolving rotor the width, will use in burning after high temperature compressed gas to feed back to the compression the burning compressed gas. The establishment has the expanded housing in on the high temperature compressed gas feedback channel endophragm, the bean establishes in the high temperature compressed gas feedback channel.

The air cylinder decomposition may have many kinds of ways, decomposes except the traditional about bottom, but also may by the axle center parallel broken minute.

One double rotors rotary engine design method, the method including the following step:

Step 1, determination optimum compression ratio;

The step 2, according to the output power, the speed range determined the rotor the quality and the width, simultaneously determine the dynamic output position;

Step 3, basis compression ratio and rotor width

Step 4, determination bean and igniter plug position.

One double rotors rotary engine running rate control method, the method including the following step:

Step K1, or outputs the gear using the locking gear and not the incomplete tooth the resistance, the impediment dynamic output first rotor;

Step K2, actuates the second rotor, forms the fuel air compression gaseous mixture with the first rotor, forms starts the metastable condition;

Step K3, the spark plug ignition, the gaseous mixture explodes, actuates the first rotor to untie the impediment, and the opposition compresses the second rotor, forms the fuel air compression gaseous mixture, the spark plug ignition, actuates the second rotor, forms the fuel air gaseous mixture with the first rotor, forms works the metastable condition;

Step K4, the work rotational speed which needs according to the engine, maintains metastable condition period of time, enters step K3.

### BRIEF DESCRIPTION OF THE DRAWINGS

FIG. 1 is this invention double rotors rotary engine schematic drawing.

Chart 2A is this invention double rotors rotary engine and so on the quality rotor speed change cycle schematic drawings.

Chart 2B is this invention double rotors rotary engine and so on quality rotor Canada prevents the bringing back the speed change cycle schematic drawing.

Chart 3A is this invention double rotors rotary engine weight rotor speed change cycle schematic drawing.

Chart 3B is this invention double rotors rotary engine weight rotor high speed running rate change cycle schematic drawing.

Chart 4A is the invention double rotors rotary engine concrete implementation example.

Chart 4B is this invention double rotors rotary engine light rotor one kind of concrete shape.

Chart 4D is this invention double rotors rotary engine locking gear one kind of concrete shape.

Chart 4E is this invention double rotors rotary engine prevents the bringing back one kind of concrete shape.

Chart 4F˜chart 4G is this invention double rotors rotary engine start auxiliary power coupling structure one kind of concrete shape.

Chart 5A is this invention double rotors rotary engine uses the gear coupling output the schematic drawing.

Chart 5B is this invention double rotors rotary engine concrete implementation example.

FIG. 6 is this invention double rotors rotary engine does not wait for the width rotor the schematic drawing.

FIG. 7 is this invention double rotors rotary engine selects the electromagnetism method to prevent the reverse schematic drawing;

### DETAILED DESCRIPTION OF THE PREFERRED EMBODIMENT

For the purpose of promotion an understanding of the principles of the invention, reference will now be made to the embodiment illustrated in the drawings and specific language will be used to describe the same.

It will nevertheless be understood that no limitation of the scope of the invention is thereby intended, such alterations and further modifications in the illustrated device, and such further applications of the principle of the invention as illustrated therein being contemplated as would normally occur to one skilled in the art to which the invention relates.

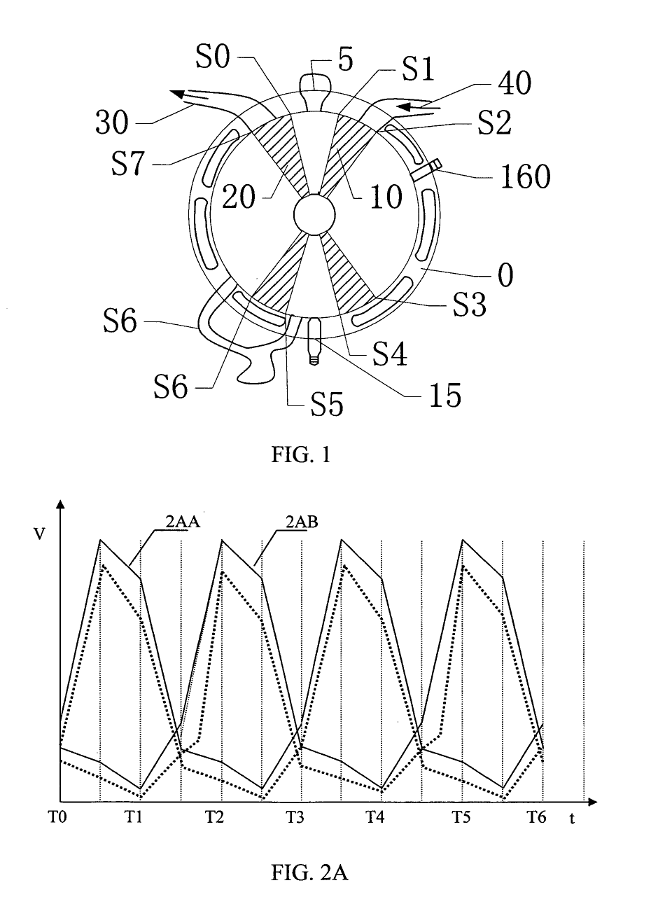

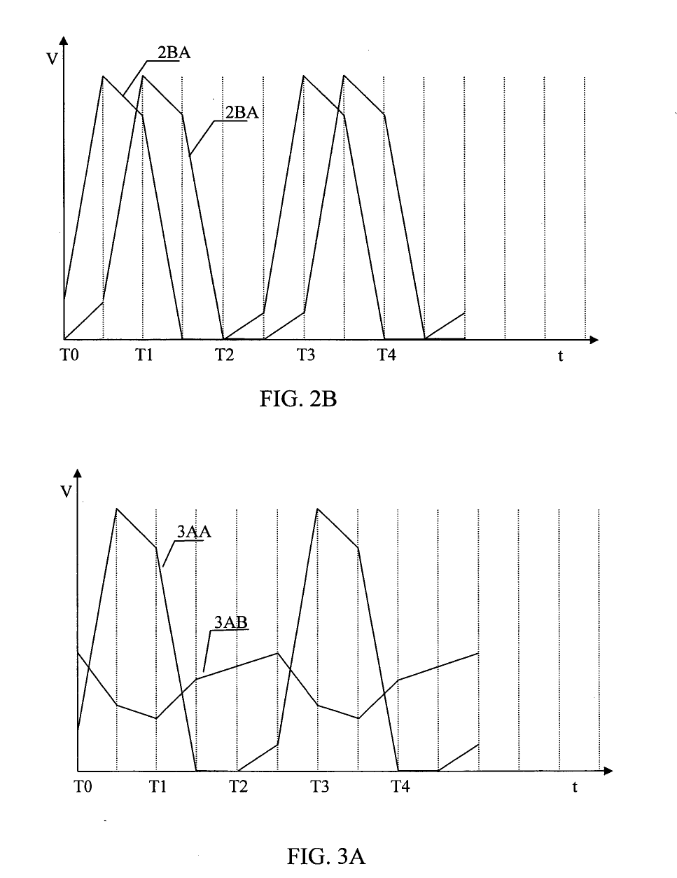

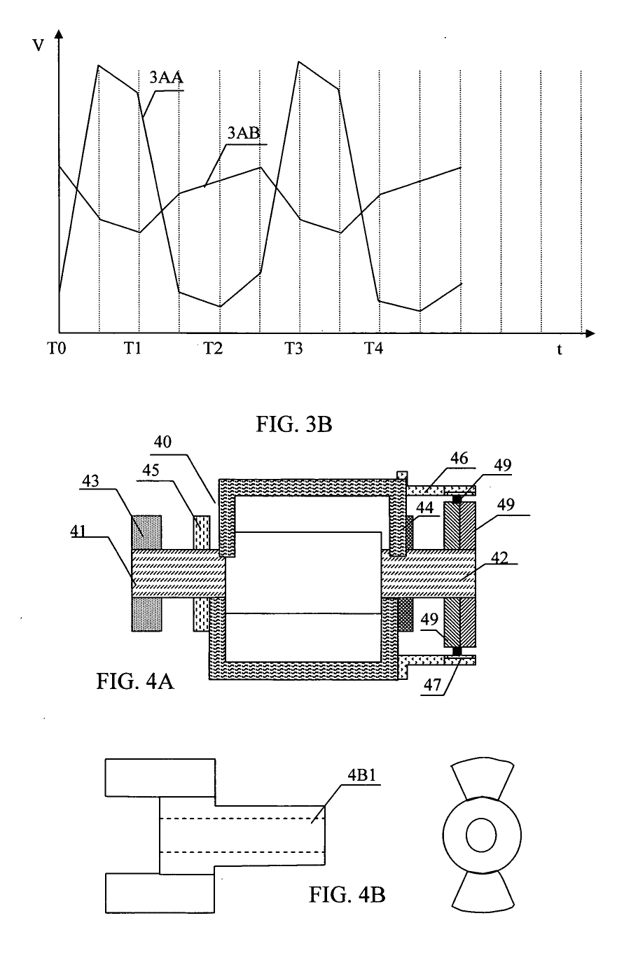

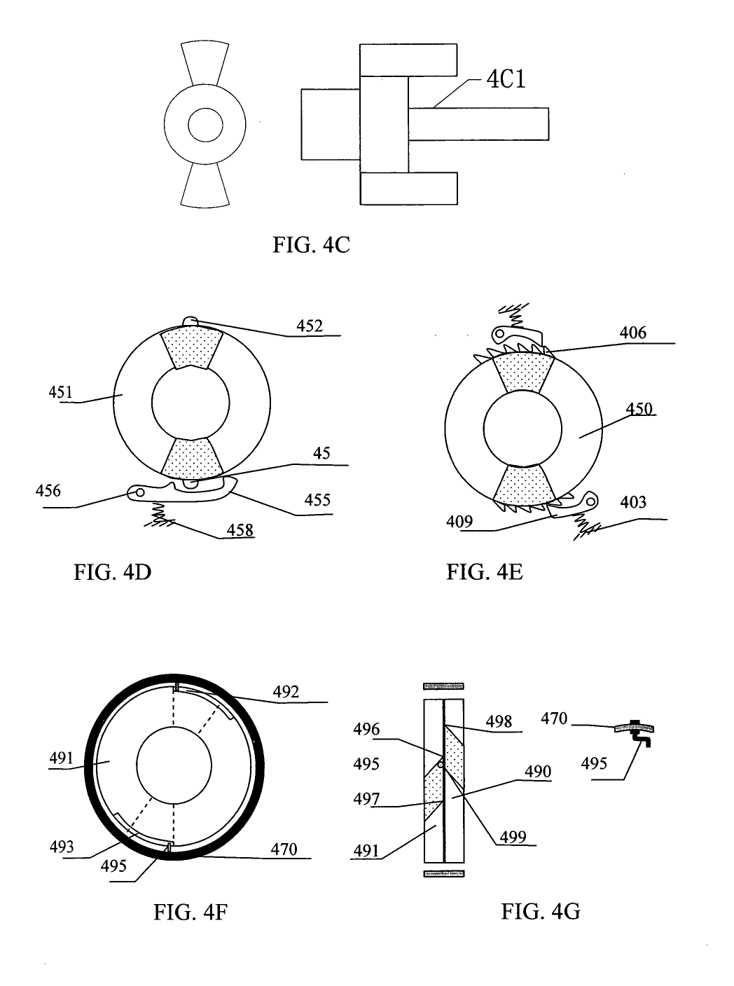

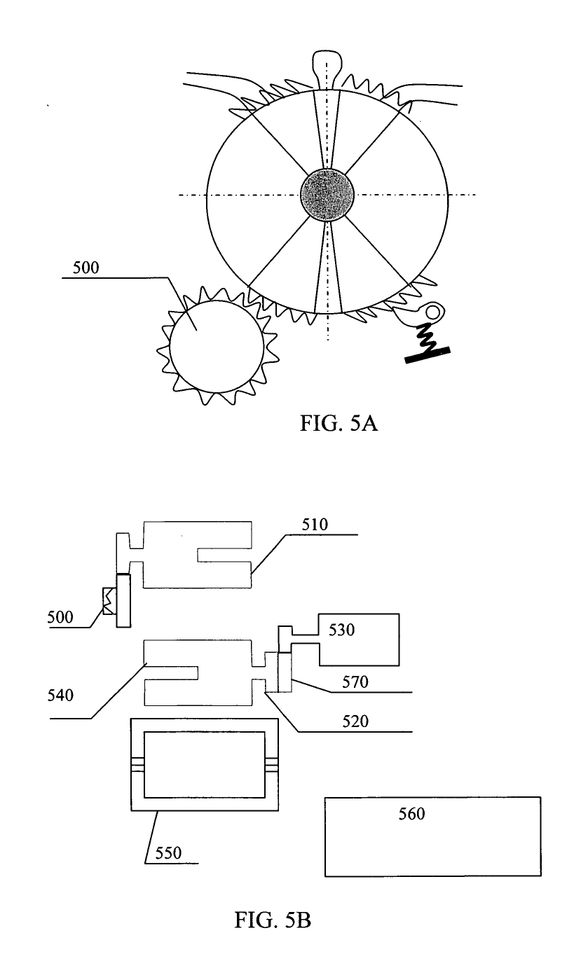

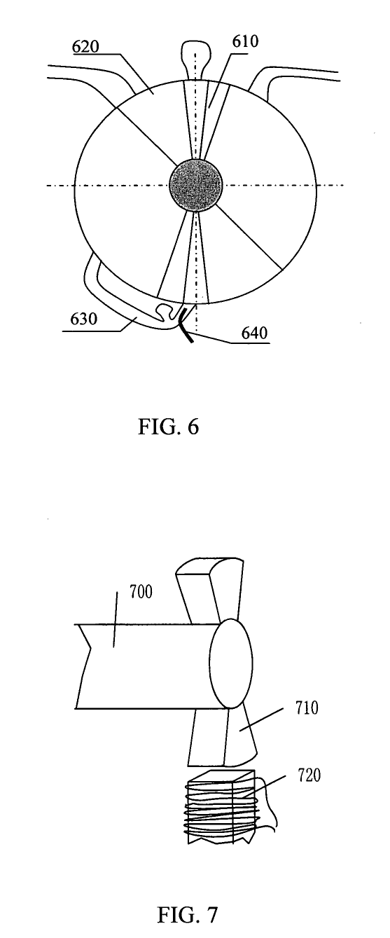

FIG. 1 is this invention double rotors rotary engine schematic drawing, the double rotors rotary engine has included the air cylinder 0, the rotor 10, the rotor 20, the air outlet channel 30 and the air inlet channel 40, like the chart has a gas buffer package between the air inlet channel and the air outlet channel 5.

The working stability of the double rotors rotary engine is a dynamic stability, its compression, the position of explodes and so on all in the dynamic change, there have the following question:

1. Between the air outlet channel and the air inlet channel, the air inlet and the exhaust is possibly interlinked.

2. When engine starts, two rotors have the possibility to be in merge, it is very difficultly to open the two rotors.

The air inlet and the air outlet direct communicate with the atmosphere may improve this question, but cannot use the waste gas the pressure, the gas buffer package5 may use this pressure.

FIG. 2 is this invention double rotors rotary engine rotor speed change cycle schematic drawing,

In FIG. 2, expressed the rotor speed change, may see by the chart in, the rotor in revolves in a week, some two peak value speed and two valley value speed, if two rotor qualities are same, all the achievement outputs the rotor, their speed change curve is consistent, must maintain the double rotors rotary engine the continually work, the request work time strict control input fuel oil and the output, guarantees two rotors the secular variations to conform to certain rule,

This rule for (peak value speed to time integral) compares on (valley value speed to time integral) to be equal to (or undulation (adds on rotor width in) S0-S1) to compare on (S2-S3 to add on rotor width), also is requests in FIG. 1, the rotor 10 changes to S4 by position S2 time, the rotor 20 changes to S6 by S4.

Like FIG. 1, the rotary engine air inlet 40 and the air outlet 30 widths, the rotor 10 and the rotor 20 widths, the igniter plug position and the firing time, have decided the engine compression ratio, if the igniter plug is at the ignition condition continuously,

Simultaneously the igniter plug position is located S5, The engine compression ratio is S2-S3 compared to on S4-S5, adjusts the rotor the width, may adjust in FIG. 2, rotor peak value speed and valley value speed, when the rotor is wider, the peak value speed and the valley value speed are smaller than. But the rotor is wider, a cyclical suction intensity are less.

The engine works, the load is changes unceasingly, therefore maintains this rule quite to be difficult, needs to examine the engine two rotors the running rates and the position, wants the strict control input fuel and the air, but also has the firing time, but also must examine the change which the load the change and the forecast is going to have, needs to use many kinds of control technology, simultaneously the cost is high.

In order to reduce the control difficulty, this invention proposed to two rotor installments prevented the reverse the installment, two rotor speed change curve like chart 2B, the rotor in revolves in, some two time sector speed is 0, simultaneously along with the power and the variation of load difference, also changes for the zero zone time, and conforms to the above rule automatically.

In order to reduce the control difficulty, this invention proposed to two rotor installments prevented the reverse the installment, two rotor speed change curve like chart 2B, the rotor in revolves in, some two time sector speed is 0, simultaneously along with the power and the variation of load difference, also changes for the zero zone time, and conforms to the above rule automatically.

Like chart 2B, the speed change frequency and the scope very are all big, to the part request and the fuel supply system, the dynamic output system, the start system request quite is all high, simultaneously designs the difficulty very is also big, but this invention proposed not equipollent rotor extremely good solution these questions, a rotor quality has been bigger than another rotor the quality, two rotor widths may same also be possible to be different, same width design, in order to achieve the quality the difference, may rotor design for hollow, or supplements the counterweight in heavy rotor outside, installs on the light rotor prevents the reverse installment, on heavy rotor coupling power output.

According to the conservation of momentum, the similar action of force in on the different quality object, the light quality quantity object, the speed change quantity which obtains is bigger than the Heavy tar quantity the object, like chart 3A, curve 3AA is the light quality quantity rotor speed change curve, 3BB is the Heavy tar quantity rotor speed change curve, when the rotor quality disparity is bigger, the heavy rotor velocity curve is smoother, the light rotor velocity curve change is bigger.

The heavy rotor quality is big, the speed change is slow, the light rotor quality is small, the speed change is quick, the heavy rotor quality is big, can play the flywheel effect, the dynamic output may role on the heavy rotor, certainly also may act according to the application the difference, the dynamic output function on the light rotor, affects on the light rotor may obtain the extremely high speed output.

The heavy rotor speed change small, stable may take the output power rotor, but the light rotor quality is small, the acceleration deceleration is easy, in under the reverse braking mechanism support, the light rotor may apply the brake to support the heavy rotor rapidly the acceleration and the dynamic output.

In the practical application, a load regarding as rotor quality part, the rotor mass ratio is the change, when the load affects to the heavy rotor on, is equal in the heavy rotor quality increase.

When outputs of the rotational speed and the power change, the weight rotor speed change curve also possibly changes for chart 3B shows. When the double rotors rotary engine work speed changes is quick, in chart 3B the velocity curve cycle changes small, but the scope fill-out, the heavy rotor average velocity increases, and this kind of change scope is big, also is the double rotors rotary engine output speed scope is big.

When affects when the heavy rotor the variation of load, in order to maintain the weight rotor the speed compared to, may change the light rotor correspondingly the counterweight, the counterweight may the dynamic coupling to on the light rotor axis.

Chart 4A is a this invention implementation example, including the air cylinder 400, has affected on the heavy rotor the dynamic output installs 430, affects on the heavy rotor the locking gear 450, affects prevents the bringing back on the light rotor 440, with start auxiliary power coupling structure 491˜499.

The air cylinder 400 is the cylindrical housing, may have the different decomposition in the project realization, like the central shaft minute, about the column cavity the basic amount, chart 4B, chart 4C is two rotors, the rotor decomposition also may have the different shape, chart 4B, in the chart 4C two rotors closes up to the heart, 400 divides into the air cylinder 4 housings, in the chart 4B rotor including cavity 4B1, in chart 4C rotor central shaft 4C1, may put on, the installment starts the auxiliary power coupling structure 490;

Chart 4D is the locking gear schematic drawing, with the rotor 410 connection turntables on 451, has breaks out 452, when breaks out 452 to change to the card to lock 455 positions, breaks out 452 to lock, also the limit movement scope, affects locks 455 in the card has spring 458, the card locks 455 to be possible fixed shaft 456 revolving, when affects as in a big way in the turntable 451 on strength as certain degree, the card locks 455 to be possible to open. The locking gear also may design when the movement opens, when start locks, reduces engine work time to rotor resistance.

The locking gear also may have many kinds of other forms, in FIG. 1 when the rotor 10 changes to the S6 position, opens rotor 20 locking, the rotor 20 changes to S6 time, opens rotor 10 locking, so circulates, may use the connecting rod impetus cam the mechanical form realization, also may use the solenoid valve and the position examines the way realization.

Chart 4E is prevented the bringing back, affects in the light rotor 420 turntables 450 for not the incomplete gear, including not the incomplete tooth 406, locks under 409 functions in the card, turntable 450 can the turn clockwise.

Like chart 4D, in the chart 4E shadow part shows, breaks out 452 and not the incomplete tooth 406 fan-shaped corresponds with the rotor.

Prevented the bringing back may have many other forms, like on bicycle flywheel. Also may use the electromagnetism the form, like FIG. 7, with the rotor spindle 700 connection magnetic induction materials 710, changes to the electro-magnet 720 positions, the electromagnet 720 circular telegrams, the magnetic induction material 710 is held, in the air cylinder the acting, after the acting completes, the electromagnet 720 breakovers, the rotor may not rotate forward, use electromagnetism technology, control nimble convenient, did not have the mechanical wear and the mechanical noise, simultaneously this structure also may with the electric motor and the generator union, outside meets the battery, the mix power engine which the composition integrates highly.

Chart 4F, chart 4G, for start auxiliary power coupling structure, turntable 490 and 491 separately through with spindle and rotor 420 and rotor 410 connections.

Like chart 4F, in the turntable 490 and on 491, all distributes has guide channel 492 and 493, the guide channel has certain drift angle, the draw key 495 may skid in the guide channel, the link turn 470 may lead draw key 495 revolving, when the link turn 470 impetus draw key 495, the draw key 495 leads turntable 491 to rotate the position which shows to like chart 4G (in chart 4G shadow part expression guide channel position), by now, the turntable 491 on guide channel beginnings 495 and the turntable 490 on guide channel end points 499 overlapped, and interlocked, in under the guide channel incline function, the draw key fell to the turntable 490 guide channels in, and fell to the turntable 490 The guide channel beginning 498, and leads turntable 490 revolving. In the chart 4F dash line expresses the guide channel and the rotor title page corresponding relations.

In the start process, the heavy rotor by locking gear locking, under the start exogenic process, the light rotor is compressed the gas, because the light rotor has prevented the bringing back the function, may not need the locking gear locking function, the compression gas is pressed explodes, either is lit by the igniter plug, impels the heavy rotor to flush the unblanking to decide structure 455 locking, and the reverse compression gas, forms the singular cycle work, if burning is not full, either has not formed the continual acting, the start auxiliary power coupling structure, can impel the heavy rotor to the anteversion, and forms the next time compression.

In the practical application, may not including the start auxiliary power coupling structure, including or including the locking gear, directly the exogenic process to a rotor on, does not lead rotor revolving, and inputs the fuel and the ignition. This start way, needs the external force instantaneous to promote a rotor the speed, makes between two rotors between air cylinder S3˜S6 the compression air fuel mixture gas, and starts the electrical machinery to need to be able to reverse, pulls open the coupling two rotors, this may unify the rotor the position examination and the electrical machinery control and the microcomputer control procedure achieved.

In FIG. 6, has the high temperature high pressure to lead the gas to feed back channel 630, feeds back the channel to be able the compressed gas which burns to feed back to the gas loading region, this region for treats burning the compression gas, in engine movement period, the high temperature feedback gas may light the compression gas, like this has safeguarded ignition dead center fixed, simultaneously enhances the compression ratio and enhances the waste gas use.

The bean position 640 in feeds back in the channel, feeds back the gas to be possible high speed to enhance the evaporation discharge.

In feeds back in the channel to have the space which the part expands, uses for to enhance the feedback gas the quality and the limit forward feedback intensity.

Chart 5A and chart 5B is revolves the rotary engine another implementation example, the rotary engine dynamic output structure output gear 500 and prevented the contra-rotation structure, in the chart dynamic output gear and the revolving rotor coupling, the coupling spot is located the rotor just to seal up the air inlet another end, in the chart is through not the incomplete tooth coupling, like this may cause the dynamic output gear the rotational speed to be steady, the reverse brake gear also is not the incomplete gear coupling, such design is in order to reduce the reverse braking mechanism to the revolving rotor frictional influence.

Outputs the gear in the design power position time, must consider the shotpoint the position, simultaneously considered the output speed the scope, the general hypothesis in the shotpoint position, simultaneously by not the incomplete tooth design, just is in the shotpoint in the revolving rotor on the time rotor not incomplete tooth and the output gear coupling. Like chart 5A, the rotor in revolves during for a cycle, two times moves the dynamic output gear. Like chart 2A, after obtains the power output, the speed change curve meets like the dashed line to show the change.

Chart 5B shows, the engine mainly included the air cylinder, the heavy rotor, the light rotor, started the electrical machinery, the reverse arresting gear, the base.

Base for each part of support, like in chart 5B air cylinder 550, because the double rotors rotary engine about has not moved the piston, the air cylinder designs the form which into fifty-fifty breaks, facilitates the installment service.

In the engine concrete application, the use locking gear, or the dynamic output gear specific coupling position, with the numerical control ignition, may realize the engine numerical control rotational speed working, changes the method to include:

Step K1, or outputs the gear with the locking gear and not the incomplete tooth the resistance, the impediment dynamic output first rotor;

Step K2, actuates the second rotor, forms the fuel air gaseous mixture with the first rotor, forms starts the metastable condition;

Step K3, the spark plug ignition, the gaseous mixture explodes, actuates the first rotor to untie the impediment, and the opposition compresses the second rotor, forms the fuel air gaseous mixture, the spark plug ignition, actuates the second rotor, forms the fuel air gaseous mixture with the first rotor, forms works the metastable condition.

Step K4, the work rotational speed which needs according to the engine, maintains metastable condition period of time, enters step K3.

Using the numerical control rotational speed working, the speed range which the double rotary engine output has become very much big, if applied on transportation vehicles and so on the automobile, might reduce the transmission gearbox the order of complexity, or cancelled the transmission gearbox completely.

In above detailed introduction this invention member, but must cause the double rotors rotary engine continuous working, needs the strict hypothesis parameter concrete step to be as follows:

Step 1, determination optimum compression ratio;

May determine the compression ratio according to the use fuel, like 10 or 15 and so on, the double rotors rotary engine compression ratios are not fixed, but can in a value undulation, first need the fuel type which uses according to the engine to establish compression ratio P. For instance is P=20;

The step 2, according to the output power, the speed range determines the rotor quality M1 and M2, definite dynamic output position; For instance determines M1/M2=20;

The definite engine power, with the output rotational speed, these two values is determined according to the demand that, for instance requests 1 horsepower output, The rotational speed is 600 revolutions/The minute, had the rotational speed and the power, may determine the rotor the quality, according to the compression ratio establishment thermal equation of energy and the rotor kinetic energy equation, may obtain the rotor quality and the width.

Regarding the weight rotor quality, needs to determine the heavy rotor and light rotor quality ratio M1/according to the demand M2 value, M1/M2 is bigger, the engine control can quite be easy, on the heavy rotor output speed range is bigger, but the light rotor speed change can be bigger, is bigger to the light rotor processing and the material request, generally speaking, M1/M2 in 10˜100, and may through change the light rotor in the dynamic coupling the quality, adjusts M1/M2 ratio.

Must pay attention, in determined rotor width time, cannot the width hypothesis too small, too small needed recently to design according to the compression, the compression ratio was big, the width requested in a big way, the compression ratio was small, the width requested slightly, generally speaking, the rotor width hypothesis was about ⅛ air cylinder circular arc. S3˜S6, also is two rotor widths adds on the smallest compression gas the width, approximately about ⅙˜¼ circular arc.

Step 3, basis compression ratio and rotor width determination air inlet and air vent distance;

Establishes the rotor width D is ⅛ circular arc;

S3S2+D+S4S5+D=½ circular arc;

S3S2/S4S5=P=20; Obtains the S3S2= 1/48 circular arc, the S4S5= 20/48 circular arc;

Air inlet and air vent distance=S3S2+¼ circular arc= 13/48 circular arc.

Step 4, determination bean and igniter plug position.

After the air inlet and the air vent distance determination, the definite igniter plug position corresponds for the air inlet to nearby the air cylinder zero point position, the bean is located the revolving rotor to revolve from the air inlet to the igniter plug between position.

May not request in the design to have the igniter plug, the fuel oil automatically by the high-pressured high temperature gas ignition.

The above detailed elaboration double rotors rotary engine composition part and the design procedure, this domain ordinary technical personnel should understand in the graphical representation the speed change chart was a schematic drawing, had certain disparity with the concrete speed change chart, but did not affect the entire invention mentality the demonstration.

Simultaneously this application has not involved the air cylinder and the rotor, between the rotor and the rotor seal technology or other technical like cooling lubrication technology, these technologies were the mature technologies, applies in the piston or on other type engine this kind of technology, all may apply in this invention, simultaneously in the double rotary engine domain, in the invention which many already applied has all contained each kind of related technology.

Although through refers to this invention certain optimal implementation example, has already carried on the graphical representation and the description to this invention, but this domain ordinary technical personnel should understand, may makes various change in the form and the detail to it, but does not deviate.

1. A double rotors rotary engine, comprising
a housing including a cylindrical cavity having inlet and outlet ports;
a first and second rotor having vanes thereon positioned within said cavity and dividing the said cavity into four individual work chambers;
a supply of fuel installment; and
a support structure.

2. The double rotors rotary engine as defined in claim 1 further comprising:
a start structure, external force through start structure coupling to rotor on;
a guards against contra-rotation structure, External force impediment revolving rotor contra-rotation.

3. The double rotors rotary engine as defined in claim 2 wherein said the first quality of the first rotor bigger than the quality of the second rotor.

4. The double rotors rotary engine as defined in claim 3 wherein the second rotor cannot the contra-rotation under the function of guards against contra-rotation structure

5. The double rotors rotary engine as defined in claim 3 wherein start structure including starts the electrical machinery, the start electrical machinery function in said the second rotor, said the auxiliary body including further to contain the output power unit, this dynamic output installment function in first revolving rotor.

6. The double rotors rotary engine as defined in claim 5 further comprising:
locking structure, on locking gear function and rotor, after a rotor is locked, another rotor changes to when establishes the position, is locked the rotor to be possible to revolve, but another rotor is locked, so circulates;
said locking gear, also may be: the locking gear only locks a rotor, but another rotor has the unblinking function, when the rotor changes to certain angle,
said locking gear only affects and the unloading phase, uses in for compressing between two rotors the gas,
after the engine rotational speed will arrive certain speed the locking gear no longer to have the fixed function.

7. The double rotors rotary engine as defined in claim 5 further comprising:
said start structure including start auxiliary power coupling structure, said the start auxiliary power coupling structure including to connect separately to two rotors on the start turntable one and the start turntable two, as soon as starts the electrical machinery or the exogamic process after starts the turntable to actuate the first rotor to compress the second rotor, transfers affects to the turntable two actuates the second rotor to compress the first rotor, so circulates, until the engine starts the work, as soon as starts the electrical machinery or the exogamic process after starts the turntable to actuate the first rotor to compress the second rotor, transfers affects to the turntable two actuates the second rotor to compress the first rotor,

8. The double rotors rotary engine as defined in claim 4 wherein said prevented the reverse equipment is the gear coupling, and said gear is entire tooth or not the incomplete tooth.

9. The double rotors rotary engine as defined in claim 4 wherein said prevented the reverse equipment is the electromagnetism form, including electromagnet, with magnetic induction material, said the magnetic induction material and the rotor is connected, when the rotor compresses the gaseous mixture, electromagnet work, holds the magnetic induction material, after gaseous mixture detonation acting, the electromagnet does not work or impels the rotor to rotate forward.

10. The double rotors rotary engine as defined in claim 4 further comprising:
on the air cylinder endophragm the establishment to have the gas buffer cavity which is interlinked with the outside atmosphere or is not interlinked, This gas buffer cavity and the bean separately are located in two section of air cylinder circular arcs which the air inlet channel and the air outlet channel divide.

11. The double rotors rotary engine as defined in claim 4 wherein in the air cylinder also to establish has at least a high temperature compressed gas feedback channel, said feeds back the channel the length to be bigger than the revolving rotor the width, will use in burning after high temperature compressed gas to feed back to the compression the burning compressed gas.

12. The double rotors rotary engine as defined in claim 11 wherein said on a high temperature compressed gas feedback channel endophragm the establishment to have the expanded housing at least, the bean establishes in said in the high temperature compressed gas feedback channel.

13. The double rotors rotary engine as defined in claim 1 wherein said air cylinder by is composed by the axle center parallel broken minute two parts.

14. A method of designing a double rotors rotary engine, including:
step 1, determination optimum compression ratio;
step 2, according to the output power, the speed range determined the rotor the quality and the width, simultaneously determine the dynamic output position;
step 3, basis compression ratio and rotor width determination air inlet and air vent distance; and
step 4, determination bean and igniter plug position.

15. A method of controlling a rotational speed of double rotors rotary engine, including the following steps:
step K1, or outputs the gear using the locking gear and not the incomplete tooth the resistance, the impediment dynamic output first rotor;
step K2, actuates the second rotor, forms the fuel air compression gaseous mixture with the first rotor, forms starts the metastable condition;
Step K3, the spark plug ignition, the gaseous mixture explodes, actuates the first rotor to untie the impediment, and the opposition compresses the second rotor, forms the fuel air compression gaseous mixture, the spark plug ignition, actuates the second rotor, forms the fuel air gaseous mixture with the first rotor, forms works the metastable condition; and
step K4, the work rotational speed which needs according to the engine, maintains metastable condition period of time, enters step K3.
